(19) United States
(12) Patent Application Publication
(10) Pub. No.: US 2007/0113962 A1
(43) Pub. Date: May 24, 2007

(54) Method of manufacturing barrier rib structure for flat display panel

(76) Inventor: Seung-Hyun Son, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/601,979

(22) Filed: Nov. 20, 2006

(30) Foreign Application Priority Data
Nov. 21, 2005 (KR) 10-2005-0111444

(51) Int. Cl. B29D 31/00; B29C 47/00; B32B 27/00

(52) U.S. Cl. 156/244.17; 156/242; 445/24

(57) ABSTRACT

Provided is a method of manufacturing a barrier rib structure for a high-definition flat display panel by using a metal. The method includes preparing a base substrate, forming a photoresist layer on the base substrate, exposing a portion of the base substrate adhered to the photoresist layer, plating an upper surface of the exposed portion with a metal for the barrier rib structure, and removing the photoresist layer to form the barrier rib structure.

### CROSS-REFERENCE TO RELATED PATENT APPLICATION

This application claims the benefit of Korean Patent Application No. 10-2005-0111444, filed on Nov. 21, 2005, in the Korean Intellectual Property Office, the disclosure of which is incorporated herein in its entirety by reference.

### BACKGROUND OF THE INVENTION

1. Field of the Invention

The present embodiments relate to a method of manufacturing a barrier rib structure for a flat display panel, and more particularly to a barrier rib structure for a flat display panel, in which discharge cells are defined in a discharge space to prevent electrical and optical disturbances between adjacent discharge cells.

2. Description of the Related Art

The luminance and discharge efficiencies of plasma display panels (PDP) are major parameters for evaluating the performance of the plasma display panels. In particular, as the resolution of plasma display panels has greatly increased, the size of each discharge cell has reduced, thus reducing the surface area of a phosphor layer applied in the discharge cell. Therefore, it is harder to increase the luminance and discharge efficiencies of plasma display panels.

In general, a barrier rib structure of a plasma display panel is formed of a non-metal material such as PbO, B₂O₃, or SiO₂. The current barrier rib structures that define discharge cells prevent electrical and optical disturbances between adjacent discharge cells but do not improve the luminance efficiency or the discharge efficiency of the panel.

However, it has been suggested that the luminance and discharge efficiencies of a plasma display panel can be improved by an effect known as the cavity effect, known as cathode discharge, which occurs when the barrier rib structure is formed of a metal material and a voltage of 0V is applied to the barrier rib structure. For example, there are papers disclosing “A Novel Shadow Mask PDP with High Luminance and Contrast” (SID (Society for Information Display) 03 DIGEST, pp. 149-151), “A Novel AC PDP with Shadow Mask” (SID 02 DIGEST, pp. 748-751), and “Three-Dimensional Investigation of a Novel Plasma Display Panel with Metal Barrier Plate” (SID 02 DIGEST, pp. 404-407).

It is known that a general etching process may be performed to manufacture a metal barrier rib structure. For example, to form the barrier rib structure on a rear substrate, a metal layer for the barrier rib structure is first deposited on the rear substrate, a screen mask is located on the metal layer for the barrier rib structure, and an etching solution is sprayed onto the screen mask to pattern the metal layer. In this case, electrodes and a dielectric layer may further be formed on the rear substrate.

The higher the resolution of panels, the narrower the interval between adjacent barrier ribs. However, to perform the etching process, the intervals between adjacent barrier ribs must be sufficient to be separated by the etching solution.

A large part of the metal layer applied onto the rear substrate, which does not become part of the barrier rib structure, is patterned and removed in the etching process, thereby increasing manufacturing costs.

### SUMMARY OF THE INVENTION

The present embodiments provide a method of manufacturing a barrier rib structure for a flat display panel, which increases the luminance and discharge efficiencies of the flat display panel.

The present embodiments also provide a method of manufacturing a barrier rib structure for a high-definition flat display panel by using a metal material.

The present embodiments also provide a method of manufacturing a low-cost barrier rib structure for a flat display panel by using a metal material.

According to an aspect of the present embodiments, there is provided a method of manufacturing a barrier rib structure for a flat display panel, the method comprising preparing a base substrate; forming a photoresist layer on the base substrate, exposing a portion of the base substrate which is adhered to the photoresist layer, plating an upper surface of the exposed portion of the base substrate with a metal for the barrier rib structure, removing the photoresist layer to form the barrier rib structure, transferring the barrier rib structure onto a substrate, and forming a dielectric layer on at least a portion of an external surface of the transferred barrier rib structure.

According to another aspect of the present embodiments, there is provided a method of manufacturing a barrier rib structure for a flat display panel, the method comprising preparing a base substrate comprising at least an upper surface formed of a metal, forming a photoresist layer on the base substrate, exposing a portion of the base substrate which is adhered to the photoresist layer, plating an upper portion of the exposed portion of the base substrate with a metal for the barrier rib structure, removing the photoresist layer to form the barrier rib structure, transferring the barrier rib structure onto a substrate, and forming a dielectric layer on at least a portion of an external surface of the transferred barrier rib structure.

The metal for the barrier rib structure can be, for example, Cu, Al, Ni, Au, and Cr or a combination thereof.

After the removal of the photoresist layer, the method may further include separating the barrier rib structure from the base substrate, wherein the base substrate may be formed of a metal which is different from the metal for the barrier rib structure. In this case, the base substrate may be formed, for example, of a material containing Ni, and the metal for the barrier structure may include, for example, Cu.

Also, the step of exposing a portion of the base substrate may include positioning a photo mask on the photoresist layer and exposing the photoresist layer, and developing the photoresist layer.

Also, the method may further include performing pre-exposure baking after the forming of the photoresist layer of the base substrate, and performing post-exposure baking on the photoresist layer after the developing of the photoresist layer.

Also, the forming of the photoresist layer on the base substrate may comprising forming an adhesive layer on the base substrate; and forming the photoresist layer on the adhesive layer. In this case, the exposing of the portion of the base substrate may comprising removing a portion of the adhesive layer which corresponds to the exposed portion of the base substrate, and the removing of the photoresist layer may comprise removing the adhesive layer.

In certain embodiments, the adhesive layer is formed of amorphous Si.

In certain embodiments, the flat display panel is a plasma display panel.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a flowchart illustrating a method of manufacturing a barrier rib structure for a flat display panel according to an embodiment;

FIG. 2 is a cross-sectional view explaining an operation of preparing a base substrate according to an embodiment, the operation being included in the method of FIG. 1;

FIG. 3 is a cross-sectional view explaining an operation of forming a photoresist layer on the base substrate of FIG. 2 according to an embodiment, the operation being included in the method of FIG. 1;

FIG. 4A is a cross-sectional view explaining an operation of performing an exposure process onto the photoresist layer according to an embodiment, the operation being included in the method of FIG. 1;

FIG. 4B is a cross-sectional view explaining an operation of developing the photoresist layer according to an embodiment, the operation being included in the method of FIG. 1;

FIG. 5 is a cross-sectional view explaining an operation of electroplating an exposed upper portion of the base substrate with metal according to an embodiment, the operating being included in the method of FIG. 1;

FIG. 6 is a cross-sectional view explaining an operation of removing the photoresist layer according to an embodiment, the operation being included in the method of FIG. 1;

FIG. 7 is a cross-sectional view explaining an operation of separating a barrier rib structure from the base substrate according to an embodiment, the operation being included in the method of FIG. 1;

FIGS. 8A through 8D are photographs showing examples of a barrier rib structure manufactured according to an embodiment.

### DETAILED DESCRIPTION OF THE INVENTION

Hereinafter, a plasma display panel according to an embodiment will be described in greater detail with reference to the accompanying drawings.

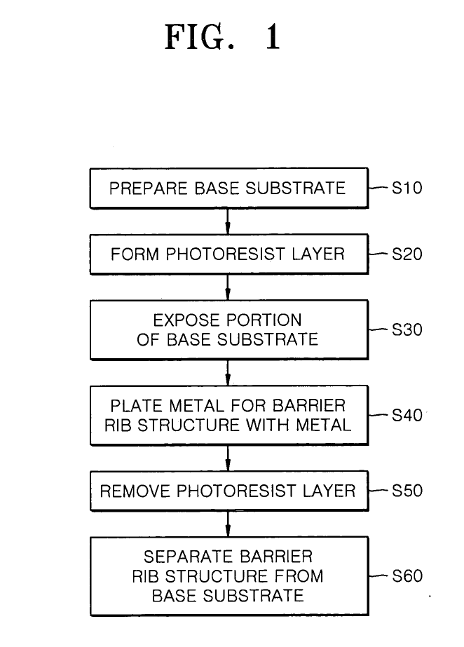

FIG. 1 is a flowchart illustrating a method of manufacturing a barrier rib structure for a flat display panel according to an embodiment. Referring to FIG. 1, the method includes preparing a base substrate (S10), forming a photoresist layer on the base substrate (S20), exposing an upper surface of the base substrate (S30), electroplating the exposed upper surface of the base substrate with metal (S40), and removing the photoresist layer form the base substrate to obtain a barrier rib structure (S50). The method may further include separating the barrier rib structure from the base substrate and transferring the separated barrier rib structure onto another substrate after the removal of the photoresist layer (S60). Otherwise, a dielectric layer may be deposited onto at least a part of an exterior surface of the transferred barrier rib structure.

According to an embodiment, a high-definition barrier rib structure is manufactured by performing an exposure process and a developing process by using a photoresist layer to expose a location where a barrier rib structure is to be formed, and by electroplating the exposed location with metal.

In this case, at least an upper surface of or the entire part of the base substrate may assume the metal's properties, and thus, a metal layer for the barrier rib structure may be formed on the base substrate through electroplating. As will be described later, if electroplating is used, electroplating can be performed on only an exposed part of the base substrate. Therefore, a method of manufacturing a barrier rib structure for a flat display panel according to an embodiment will be described with respect to electroplating. However, the present embodiments are not limited to electroplating. For example, an exposed part of the base substrate through a gap in the photoresist layer can be plated with metal according to various electroless plating methods.

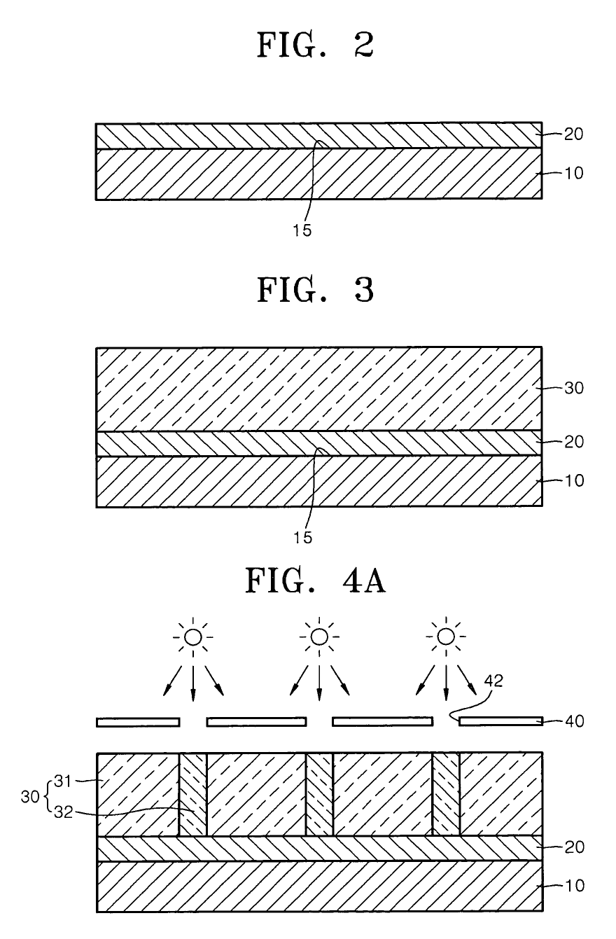

FIGS. 2 through 7 are cross-sectional views explaining the method of manufacturing a barrier rib structure for a flat display panel illustrated in FIG. 1 according to some embodiments. The operations of the method of FIG. 1 will now be described in greater detail with reference to FIG. 1 through FIG. 7.

Referring to FIG. 2, a base substrate 10 is prepared (S10). At least an upper surface 15 of base substrate 10 or the whole of the base substrate 10 may assume the metal's properties to charge the base substrate 10 with electricity during electroplating.

An adhesive layer 20 may be deposited on the base substrate 10. The adhesive layer 20 is interposed between the base substrate 10 and a photoresist layer 30 of FIG. 3, which will be described later, to adhere the base substrate 10 and the photoresist layer 30 together. In particular, if the photoresist layer 30 is formed of a material such as SU-8 50 (Microchem Corp., Newton Mass.), the adhesive layer 20 is needed since it is difficult to adhere the photoresist layer 30 to the base substrate 10. In this case, the adhesive layer 20 may be formed of amorphous Si.

Next, as illustrated in FIG. 3, a thick photoresist layer 30 is formed on the base substrate 10 (S20) by using a spin coating method or various other methods.

The photoresist layer 30 contains foreign substances such as a solvent and water. Thus, after forming the photoresist layer 30, pre-exposure baking may be performed on the photoresist layer 30 to remove such foreign substances.

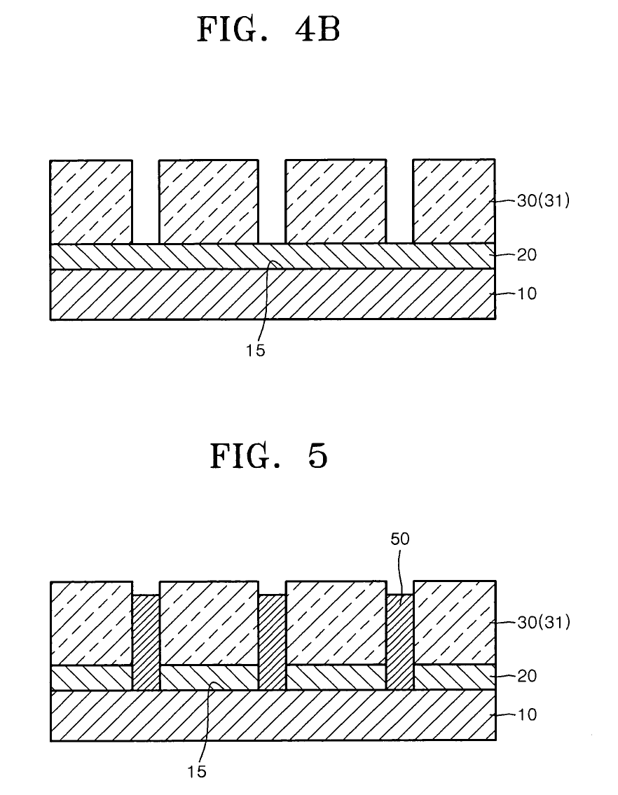

Next, as illustrated in FIGS. 4A and 4B, portions of the upper surface 15 of the base substrate 10 (upper surface 15 is not shown in FIGS. 4A and 4B and the adhesive layer 20 is exposed not the upper surface 15) adhered to the photoresist layer 30 are exposed (S30). The exposed portions of the base substrate 10 will become cross-sections of the barrier rib structure, which will be described later. Thus, in operation S30, a photo mask 40 is positioned on the photoresist layer 30 and the photoresist layer 30 is exposed as illustrated in FIG. 4A, and the photoresist layer 30 is developed as illustrated in FIG. 4B.

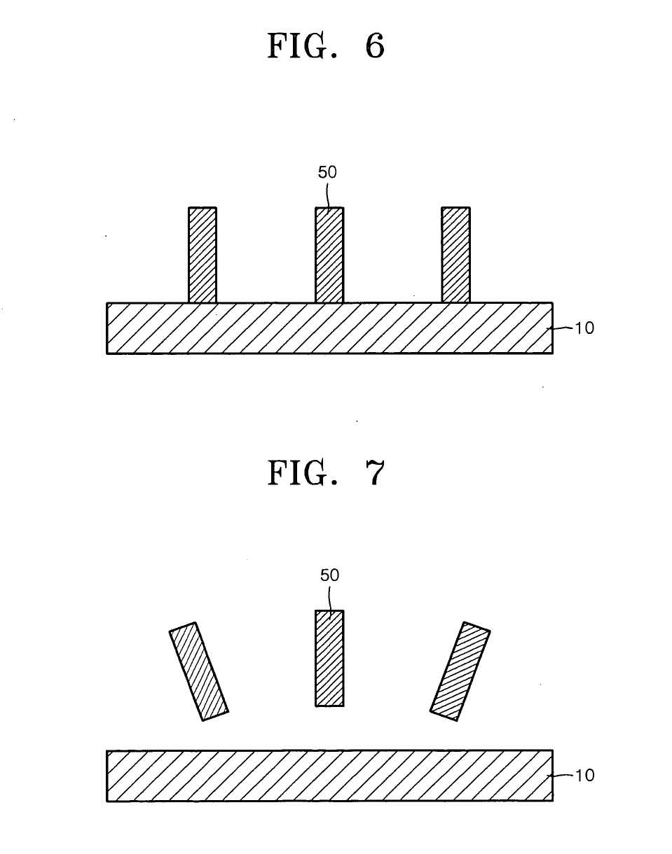

Specifically, the photo mask 40 in which mask holes 42 having the same pattern as the shape of a barrier rib structure 50 of FIG. 6 are formed, is positioned on the photoresist layer 30, and an exposure process is performed on the photo mask 40 on the photoresist layer 30. Exposed portions 32 of the photoresist layer 30 are removed through a developing process, and unexposed portions 31 of the photoresist layer 30 thereof that are blocked by the photo mask 40 are maintained even after the developing process.

If the adhesive layer 20 is deposited on the base substrate 10, portions of the adhesive layer 20, which correspond to the exposed portions 32 of the photoresist layer 30, are preferably removed.

After performing the exposure process and the developing process on the photoresist layer 30, post-exposure baking may be performed on the photoresist layer 30 to reduce residual stress of the photoresist layer 30 and improve the hardness thereof.

Next, as illustrated in FIG. 5, the exposed portion of the upper surface 15 of the base substrate 10 is plated with metal to form a barrier rib structure 50 (S40) through electroplating if desired, in operation S40. That is, since at least the upper surface 15 of the base substrate 10 assumes the metal's properties, the base substrate 10 may be charged with electricity or exposed portions of the upper surface 15 of the base substrate 10 may be plated with the metal for the barrier rib structure 50 through electroplating. Also, unexposed portions of the base substrate 10 are adhered to the photoresist layer 30 and therefore are not plated with the metal.

In this embodiment, the metal for the barrier rib structure 50 may include at least one metal, examples of which are Cu, Al, Ni, Au, and Cr or combinations thereof. If the barrier rib structure 50 is comprised of at least one selected from the group, a cavity effect known as cathode discharge occurs therein, thus improving the luminance and discharge efficiencies of the flat display panel. That is, electrons are reflected onto a discharge space in the barrier rib structure 50, plamsa electron are significantly increased to increase the plasma density, thereby improving the luminance and discharge efficiencies of the flat display panel. In particular, the high-definition barrier rib structure 50 manufactured according to an embodiment maximizes the cavity effect. In this case, UV-LIGA (Ultraviolet-Lithographie, Galvanoformung Abformung) technology may be used.

As will be described later, the metal barrier rib structure 50 may be separated from the base substrate 10 (S60). In this case, the base substrate 10 is used as a base material for forming the barrier rib structure 50. The formed barrier rib structure 50 is separated from the base substrate 10 and located on a front substrate or a rear substrate. The properties and shapes of the metal for the barrier rib structure 50 are preferably different from those of metal for the base substrate 10 so that the metal for the barrier rib structure 50 can be easily separated from the base substrate 10 due to stress between the barrier rib structure 50 and the base substrate 10. In this case, the material for the upper surface 15 of the base substrate 10 (why not the entire base substrate 10) may contain Ni and the metal for the barrier rib structure 50 may contain Cu.

Next, as illustrated in FIG. 6, the photoresist layer 30 is removed (S50). In operation S50, an exclusive stripper may be used or O₂ plasma etching may be performed to remove the photoresist layer 30. However, the method of removing the photoresist layer 30 is not limited thereto.

If the adhesive layer 20 remains on the base substrate 10, it is also removed in operation S50.

Next, as illustrated in FIG. 7, the barrier rib structure 50 may be separated from the base substrate 10 (S60). The barrier rib structure 50 may be formed for each panel so that the entire barrier rib structure 50 can be separated from the base substrate 10 and combined with a substrate of the panel. In this case, the barrier rib structure 50 and the base substrate 10 are preferably formed of different metals.

The base substrate 10 may be a rear substrate of a plasma display panel, and in this embodiment, the barrier rib structure 50 need not be separated from the base substrate 10.

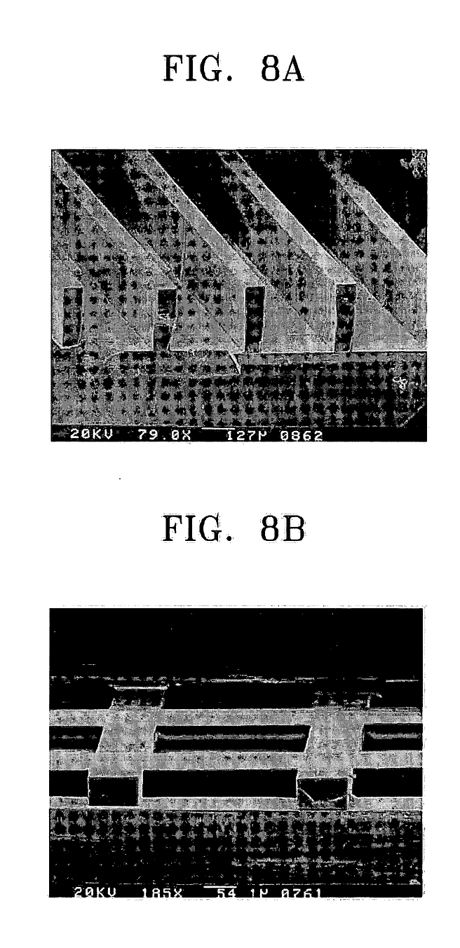

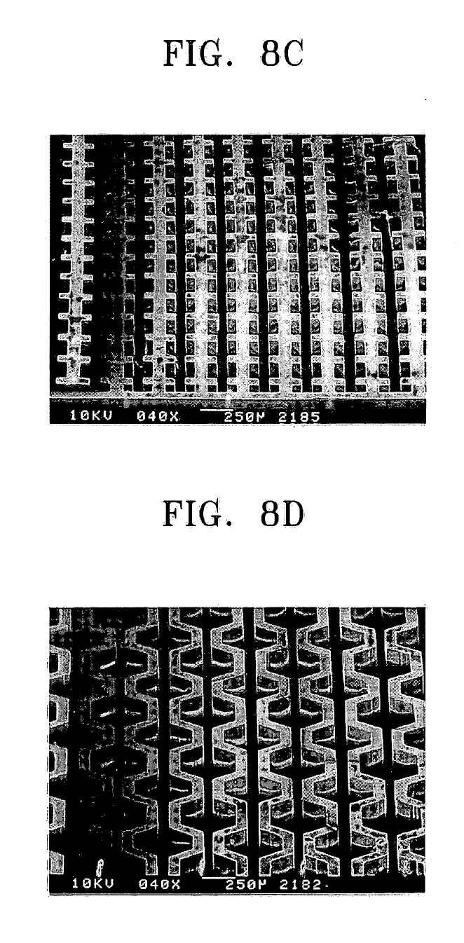

FIGS. 8A through 8D are photographs showing examples of the barrier rib structure 50 manufactured according to some embodiments. FIG. 8A shows a stripe type barrier rib structure manufactured according to an embodiment. FIG. 8B shows a box type barrier rib structure 50 according to an embodiment. FIG. 8C shows a fish-bone type barrier rib structure according to an embodiment. FIG. 8D shows a meander type barrier rib structure according to an embodiment. The examples of the barrier rib structure 50 shown in FIGS. 8A through 8D are high-definition barrier rib structures.

The flat display panel is preferably a plasma display panel, since according to the present embodiments, the plasma density can be increased by increasing the number of times that a plasma gas filled in a discharge space of the plasma display panel is discharged.

According to the present embodiments, a high-definition metal barrier rib structure can be formed to improve the luminance and discharge efficiencies of the flat display panel. According to the present embodiments, the plasma density of the flat display panel is increased.

Also, according to the present embodiments, the amount of metal needed to manufacture the barrier rib structure is less than the amount of metal needed in the prior art. For example, in a conventional etching process, a large amount of metal is applied and is then removed. However, in the present embodiments, no metal is removed, thereby minimizing manufacturing costs.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A method of manufacturing a barrier rib structure for a flat display panel, comprising:
preparing a base substrate;
forming a photoresist layer on the base substrate;
exposing a portion of the base substrate which is adhered to the photoresist layer;
plating an upper surface of the exposed portion of the base substrate with a metal for the barrier rib structure;
removing the photoresist layer to form the barrier rib structure;
transferring the barrier rib structure onto a substrate; and
forming a dielectric layer on at least a portion of an external surface of the transferred barrier rib structure.

2. The method of claim 1, wherein the metal for the barrier rib structure comprises at least one selected from the group consisting of Cu, Al, Ni, Au, Cr and combinations thereof.

3. The method of claim 1, further comprising the step of:
separating the barrier rib structure from the base substrate,
wherein the base substrate is formed of a metal which is different from the metal for the barrier rib structure.

4. The method of claim 1, wherein the base substrate is formed of a material containing Ni, and the metal for the barrier rib structure comprises Cu.

5. The method of claim 1, wherein the exposing a portion of the base substrate comprises:
positioning a photo mask on the photoresist layer;
exposing the photoresist layer; and
developing the photoresist layer.

6. The method of claim 1, wherein the forming of the photoresist layer on the base substrate comprises:
forming an adhesive layer on the base substrate; and
forming the photoresist layer on the adhesive layer,
and wherein the exposing of the portion of the base substrate comprises removing a portion of the adhesive layer which corresponds to the exposed portion of the base substrate, and wherein
the removing of the photoresist layer comprises removing the adhesive layer.

7. A method of manufacturing a barrier rib structure for a flat display panel, comprising:
preparing a base substrate comprising at least an upper surface formed of a metal;
forming a photoresist layer on the base substrate;
exposing a portion of the base substrate which is adhered to the photoresist layer;
plating an upper portion of the exposed portion of the base substrate with a metal for the barrier rib structure;
removing the photoresist layer to form the barrier rib structure;
transferring the barrier rib structure onto a substrate; and
forming a dielectric layer on at least a portion of an external surface of the transferred barrier rib structure.

8. The method of claim 7, wherein the metal for the barrier rib structure comprises at least one selected from the group consisting of Cu, Al, Ni, Au, Cr and combinations thereof.

9. The method of claim 7, further comprising separating the barrier rib structure from the base substrate,
wherein the base substrate is formed of a metal which is different from the metal for the barrier rib structure.

10. The method of claim 7, wherein the base substrate is formed of a material containing Ni, and the metal for the barrier rib structure comprises Cu.

11. The method of claim 7, wherein the exposing a portion of the base substrate comprises:
positioning a photo mask on the photoresist layer and exposing the photoresist layer; and
developing the photoresist layer.

12. The method of claim 7, further comprising the steps of:
after the forming of the photoresist layer of the base substrate, performing pre-exposure baking; and
after the developing of the photoresist layer, performing post-exposure baking on the photoresist layer.

13. The method of claim 7, wherein the forming of the photoresist layer on the base substrate comprises:
forming an adhesive layer on the base substrate; and
forming the photoresist layer on the adhesive layer; and wherein
the exposing of the portion of the base substrate comprises removing a portion of the adhesive layer which corresponds to the exposed portion of the base substrate, and wherein
the removing of the photoresist layer comprises removing the adhesive layer.

14. The method of claim 13, wherein the adhesive layer is formed of amorphous Si.

15. The method of claim 7, wherein the flat display panel is a plasma display panel.

16. The method of claim 7, wherein the barrier rib structure is at least one selected from the group consisting of a stripe type structure, a box type structure, a fish-bone structure and a meander type structure.
